(19) United States
(12) Patent Application Publication
(10) Pub. No.: US 2025/0247550 A1
(43) Pub. Date: Jul. 31, 2025

(54) METHOD FOR ENCODING, METHOD FOR DECODING, AND DECODER

(71) Applicant: GUANGDONG OPPO MOBILE TELECOMMUNICATIONS CORP., LTD., Dongguan (CN)

(72) Inventors: Fuzheng YANG, Dongguan (CN); Ming LI, Dongguan (CN)

(21) Appl. No.: 19/180,628

(22) Filed: Apr. 16, 2025

Related U.S. Application Data
(63) Continuation of application No. PCT/CN2022/125864, filed on Oct. 18, 2022.

(51) Int. Cl. H04N 19/167; G06T 9/00; H04N 19/169; H04N 19/96

(52) U.S. Cl. CPC H04N 19/167; G06T 9/001; H04N 19/1883; H04N 19/96

(57) ABSTRACT

A method for decoding includes: first parameter information of a current node is determined; context indication information of the current node is determined according to the first parameter information; a context model is determined according to the context indication information; and a bitstream is decoded based on the context model to determine plane position information of the current node in a preset direction.

### CROSS-REFERENCE TO RELATED APPLICATION

This application is a continuation of International Application No. PCT/CN2022/125864 filed on Oct. 18, 2022, the disclosure of which is hereby incorporated by reference in its entirety.

### TECHNICAL FIELD

Embodiments of the present disclosure relate to the technical field of point cloud encoding and decoding, in particular to a method for encoding, a method for decoding, and a decoder.

### BACKGROUND

In the Geometry-based Point Cloud Compression (G-PCC) encoding and decoding framework, the geometry information of the point cloud and attribute information corresponding to the geometric information are coded separately. The coding of geometric information is classified into two frameworks based on Octree and Trisoup.

In the geometric information coding framework based on octree, a large amount of information needs to be stored for constructing context models in related art, which results in a high consumption of storage space.

### BRIEF DESCRIPTION OF THE DRAWINGS

FIG. 1 is a schematic diagram of network architecture of point cloud encoding and decoding.

FIG. 2 is a schematic diagram of a composition framework of a G-PCC encoder.

FIG. 3 is a schematic diagram of a composition framework of a G-PCC decoder.

FIG. 4 is a flowchart of a method for decoding according to an embodiment of the present disclosure.

FIG. 5 is a flowchart of a method for encoding according to an embodiment of the present disclosure.

FIG. 6 is a detailed flowchart of a method for encoding and decoding according to an embodiment of the present disclosure.

FIG. 7 is a schematic diagram of a composition structure of an encoder according to an embodiment of the present disclosure.

FIG. 8 is a schematic diagram of a specific hardware structure of an encoder according to an embodiment of the present disclosure.

FIG. 9 is a schematic diagram of a composition structure of a decoder according to an embodiment of the present disclosure.

FIG. 10 is a schematic diagram of a specific hardware structure of a decoder according to an embodiment of the present disclosure.

FIG. 11 is a schematic diagram of a composition structure of an encoding and decoding system according to an embodiment of the present disclosure.

### DETAILED DESCRIPTION

In order to provide a more detailed understanding of the features and technical contents of the embodiments of the present disclosure, the implementation of the embodiments of the present disclosure will be described in detail below with reference to the drawings, which are for reference and illustration only, and are not intended to limit the embodiments of the present disclosure.

Unless otherwise defined, all technical and scientific terms used herein have the same meaning as commonly understood by those skilled in the art belonging to the present disclosure. The terminology used herein is for the purpose of describing embodiments of the present disclosure only and is not intended to limit the present disclosure.

In the following description, reference is made to “some embodiments”, which describes a subset of all possible embodiments, but it may be understood that “some embodiments” may be the same subset or different subsets of all possible embodiments, and may be combined with each other without conflict. It should also be pointed out that the terms “first\ second\third” referred to in the embodiments of the present disclosure are only used to distinguish similar objects, and do not represent a specific ordering for the objects. It may be understood that “first\second\third” may be interchanged with a specific order or a priority order where allowed, so that the embodiments of the present disclosure described herein may be implemented in an order other than that illustrated or described herein.

Before further describing the embodiments of the present disclosure in detail, the terms and phrases related to the embodiments of the present disclosure will be described firstly, and the terms and phrases related to the embodiments of the present disclosure are applicable to the following explanations:
Point Cloud Compression (PCC);
Geometry-based Point Cloud Compression (G-PCC or GPCC);
Video-based Point Cloud Compression (V-PCC or VPCC);
Octree;
Triangle soup (Trisoup);
Intra Prediction;
Look Up Table (LUT);
Red-Green-Blue (RGB);
Luminance-Chrominance (YUV);
Level of Detail (LOD);
Predicting Transform;
Lifting Transform;
Region Adaptive Hierarchal Transform (RAHT);
Context-based Adaptive Binary Arithmetic Coding (CABAC).

It may be understood that Point Cloud is a three-dimensional representation of the surface of an object. The Point Cloud (data) on the surface of an object may be collected through a collection device such as photoelectric radar, lidar, laser scanner, and multi-view camera.

Further, the point cloud refers to a set of a large number of three-dimensional points. The points in the point cloud may include position information of the points and attribute information of the points. For example, the position information of the points may be three-dimensional coordinate information of the points. The position information of the points may also be referred to as the geometric information of the points. For example, the attribute information of the points may include colour information and/or reflectivity, and the like. For example, the colour information may be any kind of information in a colour space. For example, the colour information may be RGB information. Here, R represents Red (R), G represents Green (G), and B represents Blue (B). As another example, the colour information may be luma-chroma (YCbCr, YUV) information. Here, Y represents brightness, Cb (U) represents blue chroma, and Cr (V) represents red chroma.

Points in the point cloud obtained according to the principle of laser measurement may include three-dimensional coordinate information of the points and laser reflectance of the points. For another example, points in the point cloud obtained according to the principle of photogrammetry may include three-dimensional coordinate information of the points and colour information of the points. For another example, points in the point cloud obtained by combining the principles of laser measurement and photogrammetry may include three-dimensional coordinate information of the points, laser reflectance of the points, and colour information of the points.

Point clouds may be classified according to acquisition method into: static point cloud, dynamic point cloud and dynamically acquired point cloud.

For the first type of static point cloud, the object is stationary, and the device that acquires the point cloud is also stationary.

For the second type of dynamic point cloud, the object is motional, but the device that acquires the point cloud is stationary.

For the third type of dynamically acquired point cloud, the device that acquires the point cloud is motional.

For example, point clouds may be classified according to purpose of the point clouds into two broad categories: machine perception point cloud and human eye perception point cloud.

The first category of the machine perception point cloud may be used in autonomous navigation systems, real-time inspection systems, geographic information systems, visual sorting robots, emergency rescue and disaster relief robots and other scenarios.

The second category of the human eye perception point cloud may be used in point cloud application scenarios such as digital cultural heritage, free viewpoint broadcasting, three-dimensional immersive communication, and three-dimensional immersive interaction.

Since the point cloud is a set of massive points, storage of the point cloud will not only consume a lot of memory, but also it is not conducive to transmission. There is no such large bandwidth to support the direct transmission of the point cloud at the network layer without compression. Therefore, it is necessary to compress the point cloud.

Up to now, the point cloud encoding framework for compressing the point cloud may be a G-PCC codec framework or a V-PCC codec framework provided by the Moving Picture Experts Group (MPEG), or an AVS-PCC codec framework provided by the Audio Video Standard (AVS). The G-PCC codec framework may be used to compress the first type of static point cloud and the third type of dynamically acquired point cloud, and the V-PCC codec framework may be used to compress the second type of dynamic point cloud. In the embodiments of the present disclosure, the G-PCC codec framework is mainly described here.

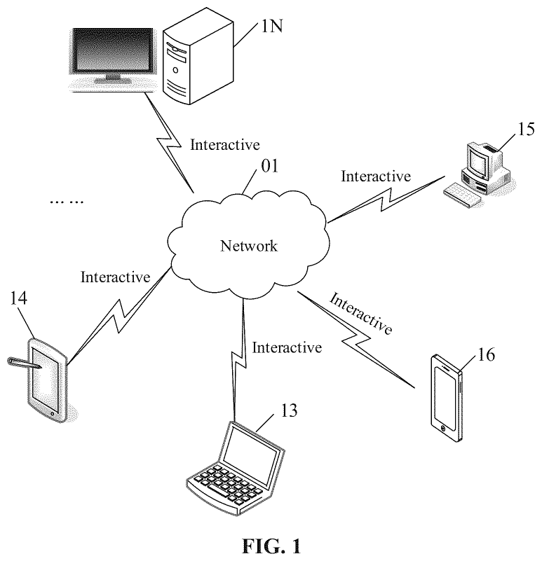

The embodiments of the present disclosure provide network architecture of a point cloud encoding and decoding system including a method for decoding and a method for encoding. FIG. 1 is a schematic diagram of network architecture of point cloud encoding and decoding according to an embodiment of the present disclosure. As illustrated in FIG. 1, the network architecture includes one or more electronic devices 13 to 1N and a communication network 01. The electronic devices 13 to 1N may perform video interaction through the communication network 01. The electronic device may be various types of devices having point cloud encoding and decoding functions in the process of implementation, for example, the electronic device may include a mobile phone, a tablet computer, a personal computer, a personal digital assistant, a navigator, a digital telephone, a video telephone, a television, a sensing device, a server, and the like, which is not limited in the embodiments of the present disclosure. The decoder or encoder in the embodiments of the present disclosure may be the electronic device described above.

The electronic device in the embodiments of the present disclosure has a point cloud encoding and decoding function, and generally includes a point cloud encoder (i.e., an encoder) and a point cloud decoder (i.e., a decoder).

The related art is described by taking the G-PCC codec framework as an example.

It may be understood that in the point cloud G-PCC codec framework, after the point cloud input to the three-dimensional picture model is sliced, each slice may be independently encoded.

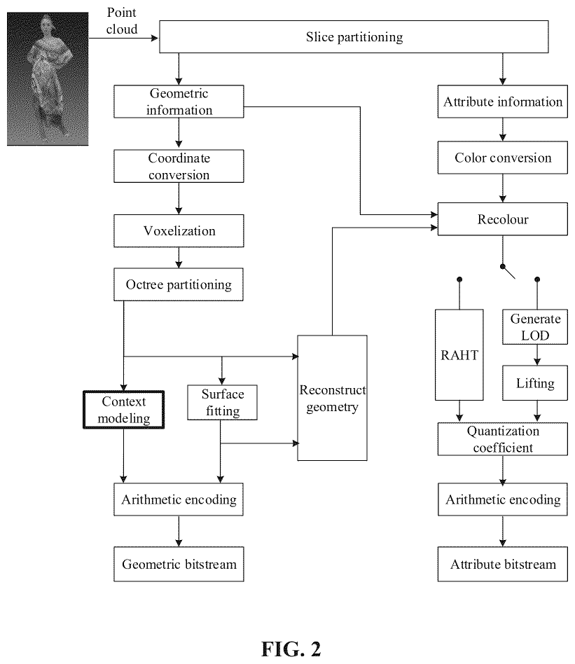

FIG. 2 is a schematic diagram of a composition framework of a G-PCC encoder.

As illustrated in FIG. 2, the G-PCC encoder is applied to a point cloud encoder. In the G-PCC encoding framework, the slices are independently encoded after the input point cloud is sliced. In slice, the geometric information of the point cloud and the attribute information corresponding to the points in the point cloud are encoded separately. The G-PCC encoder firstly encodes the geometric information. The encoder performs coordinate transformation on the geometric information to include all the point cloud in a bounding box. Then quantization is performed. This operation of quantization mainly plays the role of scaling. Because of the quantization rounding, the geometric information of some points is the same. Whether to remove duplicate points is determined according to parameters. The process of quantization and removing duplicate points is also called Voxelization process. Next, the bounding box is partitioned based on an octree. According to the different depths of partition levels of octree, the encoding of geometric information is classified into two frameworks based on octree and trisoup.

In the geometric information coding framework based on octree, the bounding box is partitioned into eight sub-cubes equally, and the occupancy bits (where 1 represents non-empty and 0 represents empty) of the sub-cubes are recorded. The non-empty sub-cubes are continuously partitioned into eight parts equally, and usually the partition is stopped when the obtained leaf nodes are 1×1×1 unit cubes. In this process, the spatial correlation between a node and surrounding nodes thereof is used to perform intra-prediction on the occupancy bits, and finally CABAC encoding is performed based on the context model to generate a binary geometric bitstream, that is, a geometric bitstream.

In the geometric information coding framework based on trisoup, it is also necessary to perform octree partition firstly, but the difference lies in comparing with geometric information encoding based on octree, in this method, the point cloud does not need to be partitioned into unit cubes with side length of 1×1×1 step by step, but the partition is stopped when the side length of blocks is W. For the surface formed based on the distribution of point cloud in each block, at most twelve vertexes between the surface and the twelve edges of the block are obtained. Finally, the vertex coordinates of each block are encoded in turn to generate a binary geometric bitstream, that is, a geometric bitstream.

The G-PCC encoder reconstructs the geometric information after completing the encoding of the geometric information, and uses the reconstructed geometric information to encode the attribute information of the point cloud. At present, the encoding of attribute of point cloud mainly involves encoding the colour information of points in point cloud. First, the encoder may perform colour space transformation on the colour information of the points. For example, when the colour information of the points in the input point cloud is represented using the RGB colour space, the encoder may transform the colour information from the RGB colour space to the YUV colour space. Then, the point cloud is recoloured by using the reconstructed geometric information to correspond the unencoded attribute information with the reconstructed geometric information. In encoding of colour information, there are two main transformation methods. One method is distance-based lifting transformation that relies on LOD partition, and the other method is direct RAHT transformation. Both methods will transform colour information from spatial domain to frequency domain to obtain high-frequency coefficients and low-frequency coefficients. Finally, the coefficients are quantized and encoded to generate a binary attribute bitstream, that is, attribute bitstream.

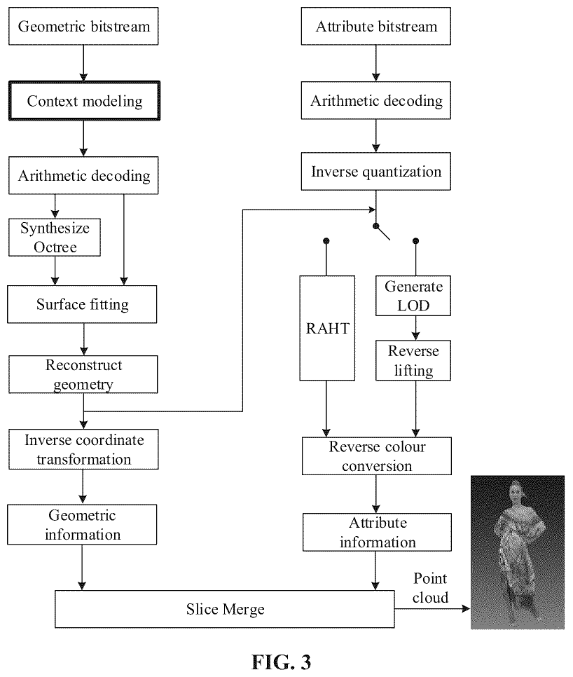

FIG. 3 is a schematic diagram of a composition framework of a G-PCC decoder.

As illustrated in FIG. 3, the G-PCC decoder is applied to a point cloud decoder. In the G-PCC decoding framework, after obtaining the binary bitstream, the geometric bitstream and the attribute bitstream in the binary bitstream are independently decoded. When decoding the geometric bitstream, the geometric information of the point cloud is obtained by the following operations: context modeling, arithmetic decoding, octree synthesis, surface fitting, reconstruction geometry and inverse coordinate transformation. When decoding the attribute bitstream, the attribute information of the point cloud is obtained by the following operations: arithmetic decoding, inverse quantization, inverse lifting based on LOD or inverse transformation based on RAHT, and inverse colour transformation. The slice to be encoded may be recovered based on the geometric information and the attribute information, and then, after slice merging, the three-dimensional picture model of the input point cloud may be restored.

In the related art, in the context modeling illustrated in FIG. 2 or FIG. 3, the neighbour geometry information may be used to perform context modeling for the codec flag bit occ_plane_pos[k] in the planar coding mode. The neighbour geometry information includes information as follows.

(1) A previous k direction plane node region variable, which represents a region value of the previous node located in the plane perpendicular to the k direction and qualified for planar coding mode.

(2) A previous k direction single-plane occupancy variable, which represents whether the previous node located in the plane perpendicular to the k direction and qualified for planar coding mode meets a condition of single-plane occupancy in the direction perpendicular to the k direction, 0 representing NO and 1 representing YES.

(3) A previous k direction plane position variable, which represents the plane position of the previous node located in the plane perpendicular to the k direction and meeting a condition of single-plane occupancy, 0 representing a low plane and 1 representing a high plane.

(4) An occupancy information variable of an adjacent node perpendicular to the k direction, 0 representing being unoccupied and 1 representing being occupied.

However, in the related art, a context model used for encoding and decoding a plane position is constructed for the planar coding mode mainly by storing and utilizing information of the node in a plane perpendicular to the k direction of the current node and qualified for planar coding mode and occupancy information of an adjacent node perpendicular to the k direction. However, in the related art, more information needs to be stored, which results in a large storage space consumption.

Based on this, the embodiments of the present disclosure provide a method for encoding. The first parameter information of a current node is determined. Context indication information of the current node is determined according to the first parameter information. A context model is determined according to the context indication information. Plane position information of the current node in a preset direction is determined according to the planar coding mode. The plane position information of the current node in the preset direction is encoded based on the context model to signal the obtained encoded bits in a bitstream.

The embodiments of the present disclosure further provide a method for decoding. The first parameter information of a current node is determined. Context indication information of the current node is determined according to the first parameter information. A context model is determined according to the context indication information. The bitstream is decoded based on the context model to determine the plane position information of the current node in the preset direction.

In this way, in the process of encoding and decoding the plane position information of the current node in the preset direction by using the context model, the construction of the context model may be determined according to the first parameter information of the current node. Compared with the amount of information required to be stored in the related art, the amount of stored information of the first parameter information is reduced, thereby saving the storage space on the premise of ensuring the encoding and decoding performance.

Hereinafter, embodiments of the present disclosure will be described in detail with reference to the drawings.

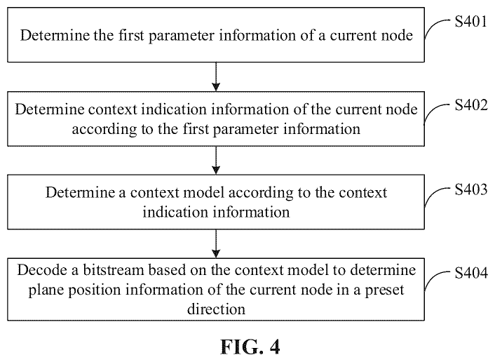

In an embodiment of the present disclosure, FIG. 4 illustrates a flowchart of a method for decoding according to an embodiment of the present disclosure. As illustrated in FIG. 4, the method may include the following operations.

In operation S401, the first parameter information of a current node is determined.

It should be noted that the method for decoding according to the embodiment of the present disclosure is applied to a decoder. In addition, the method for decoding may specifically refer to a method for decoding point cloud, and more specifically, a context modeling method based on a point cloud planar coding mode and used for constructing a context model.

It should also be noted that in the point cloud, the points may be all points in the point cloud or part of points in the point cloud, and these points are relatively concentrated in space.

It should also be noted that, for the framework based on the G-PCC decoder illustrated in FIG. 3, the method of the embodiment of the present disclosure is mainly applied to the “context modeling” portion. In view of the problem that there is a large amount of information required to be stored for constructing a context model in the related art, the consumption of storage space can be reduced by the embodiment of the present disclosure, thereby achieving the purpose of saving storage space.

In some embodiments, the operation of determining the first parameter information of the current node may include determining decoding parameter information required by the current node in a decoding process. The decoding parameter information includes at least one of: plane information of decoded nodes, or occupancy information of an adjacent node.

It should be understood that in the embodiment of the present disclosure, the first parameter information may include decoding parameter information required by the current node in the decoding process. The context model may be determined by using these pieces of decoding parameter information, and plane position information can be decoded through the context model.

Further, when the context model is constructed for decoding plane position information, for the decoding parameter information, context modeling may be performed by using neighbouring geometry information, and specifically, in the related art, context modeling may be performed by using information of the node in a plane perpendicular to the k direction of the current node and qualified for planar coding mode and occupancy information of an adjacent node perpendicular to the k direction. In order to save storage space, in the embodiment of the present disclosure, the information of the node qualified for the planar coding mode is no longer required, and only the plane information of the decoded nodes and/or the occupancy information of the adjacent node may be used for context modeling.

It should also be understood that in the embodiment of the present disclosure, the plane information of the decoded nodes may specifically refer to the plane information of the nodes decoded by using the planar coding mode. The planar coding mode is an encoding mode adopted by the current node, which may be referred to as “Planar Mode” for short.

In addition, the occupancy information of the adjacent node may be specifically determined according to whether a point is occupied in the adjacent node. In some embodiments, the operation of determining the occupancy information of the adjacent node may include: determining that the occupancy information of the adjacent node is equal to 1 if a point is occupied in the adjacent node, and determining that the occupancy information of the adjacent node is equal to 0 if no point is occupied in the adjacent node.

In the embodiment of the present disclosure, the adjacent node may include at least one of the following: a neighbouring node coplanar with the current node, a neighbouring node collinear with the current node, or a neighbouring node co-point with the current node.

That is, at least one point may be obtained by spatially partitioning the point cloud. An adjacent node of the current node is determined from the at least one point according to the geometric position of the current node. Typically, the number of adjacent nodes of the current node may be many. Exemplarily, the number of neighbouring nodes coplanar with the current node is 6, the number of neighbouring nodes collinear with the current node is 12, and the number of neighbouring nodes co-point with the current node is 8, which is not limited in the present disclosure.

That is to say, if a node is occupied in a certain adjacent node, the occupancy information of the adjacent node is equal to 1, and if no point is occupied in a certain neighbouring node, the occupancy information of the adjacent node is equal to 0. On the contrary, if the occupancy information of an adjacent node is equal to 1, it means that a point is occupied in the adjacent node, and if the occupancy information of an adjacent node is equal to 0, it means that no node is occupied in the adjacent node.

In operation S402, context indication information of the current node is determined according to the first parameter information.

It should be noted that, after the first parameter information is determined, the context indication information of the current node may be determined based on the first parameter information. The context indication information may include the first context indication information and the second context indication information.

In the embodiment of the present disclosure, the first context indication information is a context indicator for indicating an adjacent plane, which may be represented by adjPlaneCtxInc. The second context indication information is a context indicator for indicating the closest plane position, which may be represented by closestPlanePosCtxInc.

In some embodiments, the operation of determining the context indication information of the current node according to the first parameter information may include the following operations.

The first enable identifier information and the second enable identifier information are determined.

The first context indication information of the current node is determined according to the first enable identifier information and the decoding parameter information.

The second context indication information of the current node is determined according to the second enable identifier information and the decoding parameter information.

In the embodiment of the present disclosure, the first enable identifier information indicates whether an octree adjacent child node is enabled, which may be represented by occtree_adjacent_child_enabled. The second enable identifier information indicates whether an octree planar buffer is disabled, which may be represented by occtree_planar_buffer_disabled.

It should be understood that, in the embodiment of the present disclosure, the determination of the value of the first context indication information is not only related to the decoding parameter information, but also has an association relationship with the first enable identifier information. In some embodiments, the operation of determining the first enable identifier information may include decoding a bitstream to determine a value of the first enable identifier information.

In a specific embodiment, the method may further include the following operation.

When the value of the first enable identifier information is the first value, it is determined that the first enable identifier information indicates that the octree adjacent child node is not enabled.

When the value of the first enable identifier information is the second value, it is determined that the first enable identifier information indicates that the octree adjacent child node is enabled.

In the embodiment of the present disclosure, the first value and the second value are different from each other for the first enable identifier information, and the first value and the second value may be in a parameter form or a digital form. Specifically, the first enable identifier information may be a parameter written in a profile, or may be a value of a flag, which is not specifically limited here.

Exemplarily, the first value may be set to 1 and the second value may be set to 0. Alternatively, the first value may be set to 0 and the second value may be set to 1. Alternatively, the first value may be set to true and the second value may be set to false. Alternatively, the first value may be set to false and the second value may be set to true. In the embodiment of the present disclosure, the first value is set to 0 and the second value is set to 1, but which is not specifically limited here.

That is, in the embodiment of the present disclosure, the first enable identifier information is a syntax element transmitted in the bitstream, and the value of the first enable identifier information may be directly determined by decoding the bitstream. Exemplarily, for the first enable identifier information (i.e., octree adjacent child node enable flag bit) occtree_adjacent_child_enabled, if the value of occtree_adjacent_child_enabled is 0, it may be determined that occtree_adjacent_child_enabled indicates that the octree adjacent child node is not enabled, and if the value of occtree_adjacent_child_enabled is 1, it may be determined that occtree_adjacent_child_enabled indicates that the octree adjacent child node is enabled.

It should be noted that, in the process of determining the first context indication information, in addition to the value of occtree_adjacent_child_enabled, for the decoding parameter information at this time, specifically, in some embodiments, the operation of determining the decoding parameter information required by the current node in the decoding process may include: determining plane information of a sibling node of the current node among the decoded nodes, plane information of a decoded node situated along the preset direction of the current node, and occupancy information of an adjacent node situated along the preset direction of the current node.

That is, in the embodiment of the present disclosure, according to the value of occtree_adjacent_child_enabled, the first context indication information may be determined by calculating in combination with the plane information of the sibling node of the current node among the decoded nodes, the plane information of the decoded node situated along the preset direction of the current node, and the occupancy information of the adjacent node situated along the preset direction of the current node.

Further, in some embodiments, the operation of determining the first context indication information of the current node according to the first enable identifier information and the decoding parameter information may include the following operation.

When the first enable identifier information indicates that the octree adjacent child node is not enabled, the first context indication information is determined by calculating according to the occupancy information of the adjacent node situated along the preset direction of the current node and the plane information of the sibling node of the current node.

Alternatively, when the first enable identifier information indicates that the octree adjacent child node is enabled, the first context indication information is determined by calculating according to the plane information of the decoded node situated along the preset direction of the current node.

It should be noted that, in the embodiment of the present disclosure, if the value of occtree_adjacent_child_enabled is 0, in this case, the first context indication information may be obtained by calculating according to occupancy information of the adjacent node situated along the preset direction of the current node and the plane information of the sibling node of the current node. If the value of occtree_adjacent_child_enabled is 1, in this case, the first context indication information may be obtained by calculating according to the plane information of the decoded node situated along the preset direction of the current node.

It should also be noted that, in the embodiment of the present disclosure, the plane information of the decoded node situated along the preset direction of the current node may specifically refer to the first plane information and the second plane information of the decoded node situated along the preset direction of the current node. Therefore, in some embodiments, the method may further include the following operations.

The first plane information and the second plane information of the decoded node situated along the preset direction of the current node are determined according to the decoding parameter information.

When the first enable identifier information indicates that the octree adjacent child node is enabled, the first context indication information is determined by calculating according to the first plane information and the second plane information of the decoded node situated along the preset direction of the current node.

That is, in the embodiment of the present disclosure, if the value of occtree_adjacent_child_enabled is 1, in this case, the first context indication information may be specifically obtained by calculating according to the first plane information and the second plane information of the decoded node situated along the preset direction of the current node.

In some embodiments, for the first plane information and the second plane information, if the first plane information is lower than the second plane information, the first plane information may be referred to as low plane information, and the second plane information may be referred to as high plane information, and if the first plane information is higher than the second plane information, the first plane information may be referred to as high plane information, and the second plane information may be referred to as low plane information. Exemplarily, if the first plane information is lower than the second plane information, the first plane information may be represented by adjNeighPlaneL, and the second plane information may be represented by adjNeighPlaneH.

In addition, in the embodiment of the present disclosure, for the decoding parameter information, the occupancy information of the adjacent node situated along the preset direction of the current node may be represented by adjNeighHL, the plane information of the sibling node of the current node may be represented by sibPlaneH, and the plane information of the decoded node situated along the preset direction of the current node may be represented by adjNeighPlaneL and adjNeighPlaneH.

It should also be understood that, in the embodiment of the present disclosure, the determination of the value of the second context indication information is not only related to the decoding parameter information, but also has an association relationship with the second enable identifier information. In some embodiments, the operation of determining the second enable identifier information may include decoding the bitstream to determine a value of the second enable identifier information.

In a specific embodiment, the method may further include the following operation.

When the value of the second enable identifier information is the first value, it is determined that the octree planar buffer is not disabled.

When the value of the second enable identifier information is the second value, it is determined that the octree planar buffer is disabled.

In the embodiment of the present disclosure, the first value and the second value are also different from each other for the second enable identifier information, and the first value and the second value may be in a parameter form or a digital form. Specifically, the second enable identifier information may be a parameter written in a profile, or may be a value of a flag, which is not specifically limited here.

Exemplarily, the first value may be set to 1 and the second value may be set to 0. Alternatively, the first value may be set to 0 and the second value may be set to 1. Alternatively, the first value may be set to true and the second value may be set to false. Alternatively, the first value may be set to false and the second value may be set to true. In the embodiment of the present disclosure, the first value is set to 0 and the second value is set to 1, but which is not specifically limited here.

That is, in the embodiment of the present disclosure, the second enable identifier information is a syntax element transmitted in the bitstream, and the value of the second enable identifier information may be directly determined by decoding the bitstream. Exemplarily, for the second enable identifier information (i.e., octree planar buffer close flag bit) occtree_planar_buffer_disabled, if the value of occtree_planar_buffer_disabled is 0, it may be determined that occtree_planar_buffer_disabled indicates that the octree planar buffer is not disabled, and if the value of occtree_planar_buffer_disabled is 1, it may be determined that occtree_planar_buffer_disabled indicates that octree planar buffer is disabled.

It should be noted that, in the process of determining the second context indication information, in addition to the value of occtree_planar_buffer_disabled, for the decoding parameter information at this time, specifically, in some embodiments, the operation of determining the decoding parameter information required by the current node in the decoding process may include: determining plane information of an adjacent node in a plane perpendicular to the preset direction of the current node and closest plane position information in the plane perpendicular to the preset direction of the current node.

That is, in the embodiment of the present disclosure, according to the value of occtree_planar_buffer_disabled, the second context indication information may be determined by calculating in combination with plane information of an adjacent node in the plane perpendicular to the preset direction of the current node and the closest plane position information in the plane perpendicular to the preset direction of the current node.

Further, in some embodiments, the operation of determining the second context indication information of the current node according to the second enable identifier information and the decoding parameter information may include the following operation.

When the second enable identifier information indicates that the octree planar buffer is not disabled, the second context indication information is determined by calculating according to the closest plane position information in the plane perpendicular to the preset direction of the current node.

Alternatively, when the second enable identifier information indicates that the octree planar buffer is disabled, the second context indication information is determined by calculating according to the plane information of the adjacent node in the plane perpendicular to the preset direction of the current node.

It should be noted that, in the embodiment of the present disclosure, if the value of occtree_planar_buffer_disabled is 0, in this case, the second context indication information may be obtained by calculating according to the closest plane position information in the plane perpendicular to the preset direction of the current node, and if the value of occtree_planar_buffer_disabled is 1, in this case, the second context indication information may be obtained by calculating according to the plane information of the adjacent node in the plane perpendicular to the preset direction of the current node.

Further, in the embodiment of the present disclosure, the plane information of the adjacent node in the plane perpendicular to the preset direction of the current node may specifically refer to the third plane information and the fourth plane information of the adjacent node in the plane perpendicular to the preset direction of the current node. Accordingly, in some embodiments, the method may further include the following operations.

The third plane information and the fourth plane information of the adjacent node in the plane perpendicular to the preset direction of the current node are determined according to the decoding parameter information.

When the second enable identifier information indicates that the octree planar buffer is disabled, the second context indication information is determined by calculating according to the third plane information and the fourth plane information of the adjacent node in the plane perpendicular to the preset direction of the current node.

That is, in the embodiment of the present disclosure, if the value of occtree_planar_buffer_disabled is 1, in this case, the second context indication information may be specifically obtained by calculating according to the third plane information and the fourth plane information of the adjacent node in the plane perpendicular to the preset direction of the current node.

In some embodiments, for the third plane information and the fourth plane information, if the third plane information is lower than the fourth plane information, the third plane information may be referred to as low plane information, and the fourth plane information may be referred to as high plane information. If the third plane information is higher than the fourth plane information, the third plane information may be referred to as high plane information, and the fourth plane information may be referred to as low plane information. Exemplarily, if the third plane information is lower than the fourth plane information, the third plane information may be represented by closestPlaneL, and the fourth plane information may be represented by closestPlaneH.

Further, in the embodiment of the present disclosure, for the decoding parameter information, the closest plane position information in the plane perpendicular to the preset direction of the current node may be represented by closestPlanePos. In some embodiments, the operation of determining the closest plane position information in the plane perpendicular to the preset direction of the current node may include the following operations. Target plane position information of a previous node located in the plane perpendicular to the preset direction and meeting a condition of single-plane occupancy is determined. The closest plane position information in the plane perpendicular to the preset direction of the current node is determined by calculating according to the third plane information and the fourth plane information of the adjacent node in the plane perpendicular to the preset direction of the current node and the target plane position information.

It should be noted that, in the embodiment of the present disclosure, it is assumed that the preset direction is the k direction, the target plane position information of a previous node located in the plane perpendicular to the k direction and meeting a condition of single-plane occupancy may be represented by PrevOccPlanePos[k][axisLoc]. Here, k represents the k direction, and axisLoc represents being located in an axisLoc plane perpendicular to the k direction.

Thus, taking the k direction as an example, the closest plane position information closestPlanePos in the plane perpendicular to the k direction of the current node may be specifically obtained by calculating according to low plane information closestPlaneL and high plane information closestPlaneH in the adjacent node in the plane perpendicular to the k direction of the current node, and the plane position information PrevOccPlanePos[k][axisLoc] of a previous node located in the plane perpendicular to the k direction of the current node and meeting a condition of single-plane occupancy.

In operation S403, a context model is determined according to the context indication information.

In operation S404, a bitstream is decoded based on the context model to determine plane position information of the current node in a preset direction.

It should be noted that, in the embodiment of the present disclosure, the context model is specifically determined according to a model index value. In some embodiments, the operation of determining the context model according to the context indication information may include the following operations. A model index value is determined by calculating according to the preset direction, the first context indication information, and the second context indication information. The context model is determined according to the model index value.

In the embodiment of the present disclosure, the model index value may be represented by CtxIdxPlanePos. The model index value may be obtained by calculating according to the preset direction, the first context indication information, and the second context indication information. Here, the first context indication information may also be referred to as an adjacent plane context indicator, which is represented by adjPlaneCtxInc, and the second context indication information may also be referred to as a closest plane position context indicator, which is represented by closestPlanePosCtxInc.

In this way, after the model index value is determined, the corresponding context model may be determined according to the model index value, and then the plane position information of the current node in the preset direction may be obtained by decoding according to the context model. It is assumed that the preset direction is the k direction. The plane position information of the current node in the k direction may be represented by occ_planar_pos [k].

Further, in some embodiments, the method may further include storing the plane position information of the current node in the preset direction to a preset plane position variable when the second enable identifier information indicates that the octree planar buffer is not disabled.

In the embodiment of the present disclosure, the preset plane position variable represents plane position information of a previous node located in a preset plane perpendicular to the preset direction and meeting a condition of single-plane occupancy, which may be represented by PrevOccPlanePos[k][axisLoc].

Specifically, taking the preset direction as the k direction as an example, if the value of the second enable identifier information is equal to 0, that is, the second enable identifier information indicates that the octree planar buffer is not disabled, then after the plane position information of the current node in the k direction is obtained by planar mode decoding, the plane position information of the current node in the k direction may be stored into the previous plane position variable PrevOccPlanePos[k][axisLoc], which represents the plane position of a previous node located in the axisLoc plane perpendicular to the k direction and meeting a condition of single-plane occupancy. If the value of this variable is equal to 0, it is represented as a low plane position. Otherwise, if the value of this variable is equal to 1, it is represented as a high plane position.

The present embodiment provides a method for decoding. The first parameter information of a current node is determined. Context indication information of the current node is determined according to the first parameter information. A context model is determined according to the context indication information. The bitstream is decoded based on the context model to determine the plane position information of the current node in the preset direction. In this way, in the process of decoding the plane position information of the current node in the preset direction by using the context model, the construction of the context model may be determined according to the first parameter information of the current node, and the amount of stored information of the first parameter information is reduced compared with the information amount required to be stored in the related art, thereby saving the storage space on the premise of ensuring the decoding performance.

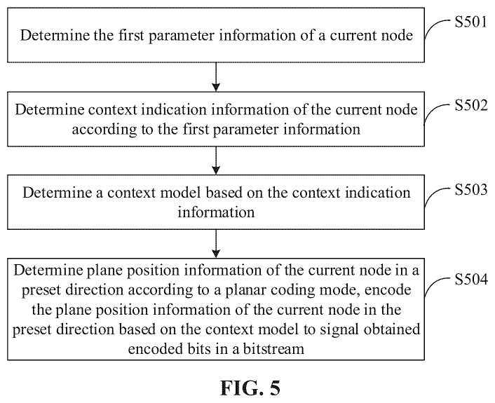

In another embodiment of the present disclosure, FIG. 5 illustrates a flowchart of a method for encoding according to an embodiment of the present disclosure. As illustrated in FIG. 5, the method may include the following operations.

In operation S501, the first parameter information of a current node is determined.

It should be noted that the method for encoding according to the embodiment of the present disclosure is applied to an encoder. In addition, the method for encoding may specifically refer to a method for encoding point cloud, and more specifically, a context modeling method based on a point cloud planar coding mode and used for constructing a context model.

It should also be noted that in the point cloud, the points may be all points in the point cloud or part of points in the point cloud, and these points are relatively concentrated in space.

It should also be noted that, for the framework based on the G-PCC encoder illustrated in FIG. 2, the method of the embodiment of the present disclosure is mainly applied to the “context modeling” portion. In view of the problem that there is a large amount of information required to be stored for constructing a context model in the related art, the consumption of storage space can be reduced by the embodiment of the present disclosure, thereby achieving the purpose of saving storage space.

In some embodiments, the operation of determining the first parameter information of the current node may include determining encoding parameter information required by the current node in an encoding process. The encoding parameter information includes at least one of: plane information of encoded nodes, or occupancy information of an adjacent node.

It should be understood that in the embodiment of the present disclosure, the first parameter information may include encoding parameter information required by the current node in the encoding process. The context model may be determined by using these pieces of encoding parameter information, and the plane position information can be encoded through the context model.

Further, when the context model is constructed for encoding plane position information, for the encoding parameter information, context modeling may be performed by using neighbouring geometric information, and specifically, in the related art, context modeling may be performed by using information of the node in a plane perpendicular to the k direction of the current node and qualified for planar coding mode and occupancy information of an adjacent node perpendicular to the k direction. In order to save storage space, in the embodiment of the present disclosure, the information of the node qualified for the planar coding mode is no longer required, and only the plane information of the encoded nodes and/or the occupancy information of the adjacent node may be used for context modeling. Here, the plane information of the encoded nodes may specifically refer to plane information of the nodes encoded by using the planar coding mode. The occupancy information of the adjacent node may be specifically determined according to whether a point is occupied in the adjacent node.

Further, in some embodiments, the operation of determining the occupancy information of the adjacent node may include: determining that the occupancy information of the adjacent node is equal to 1 if a point is occupied in the adjacent node, and determining that the occupancy information of the adjacent node is equal to 0 if no point is occupied in the adjacent node.

In the embodiment of the present disclosure, the adjacent node may include at least one of the following: a neighbouring node coplanar with the current node, a neighbouring node collinear with the current node, or a neighbouring node co-point with the current node.

That is, at least one point may be obtained by spatially partitioning the point cloud. An adjacent node of the current node is determined from the at least one point according to the geometric position of the current node. Typically, the number of adjacent nodes of the current node may be many. Exemplarily, the number of neighbouring nodes coplanar with the current node is 6, the number of neighbouring nodes collinear with the current node is 12, and the number of neighbouring nodes co-point with the current node is 8, which is not limited in the present disclosure.

That is to say, if a node is occupied in a certain adjacent node, the occupancy information of the adjacent node is equal to 1, and if no point is occupied in a certain neighbouring node, the occupancy information of the adjacent node is equal to 0. On the contrary, if the occupancy information of an adjacent node is equal to 1, it means that a point is occupied in the adjacent node, and if the occupancy information of an adjacent node is equal to 0, it means that no node is occupied in the adjacent node.

In operation S502, context indication information of the current node is determined according to the first parameter information.

It should be noted that, after the first parameter information is determined, the context indication information of the current node may be determined based on the first parameter information. The context indication information may include the first context indication information and the second context indication information.

In the embodiment of the present disclosure, the first context indication information is a context indicator for indicating an adjacent plane, which may be represented by adjPlaneCtxInc. The second context indication information is a context indicator for indicating the closest plane position, which may be represented by closestPlanePosCtxInc.

In some embodiments, the operation of determining the context indication information of the current node according to the first parameter information may include the following operations.

The first enable identifier information and the second enable identifier information are determined.

The first context indication information of the current node is determined according to the first enable identifier information and the encoding parameter information.

The second context indication information of the current node is determined according to the second enable identifier information and the encoding parameter information.

In the embodiment of the present disclosure, the first enable identifier information indicates whether an octree adjacent child node is enabled, which may be represented by occtree_adjacent_child_enabled. The second enable identifier information indicates whether an octree planar buffer is disabled, which may be represented by occtree_planar_buffer_disabled.

It should be understood that, in the embodiment of the present disclosure, the determination of the value of the first context indication information is not only related to the encoding parameter information, but also has an association relationship with the first enable identifier information. In some embodiments, the operation of determining the first enable identifier information may include the following operation.

When the first enable identifier information indicates that the octree adjacent child node is not enabled, it is determined that the value of the first enable identifier information is the first value.

When the first enable identifier information indicates that the octree adjacent child node is enabled, it is determined that the value of the first enable identifier information is the second value.

Further, in some embodiments, the method may further include the following operation. The value of the first enable identifier information is encoded to signal obtained encoded bits in the bitstream.

In the embodiment of the present disclosure, the first value and the second value are different from each other for the first enable identifier information, and the first value and the second value may be in a parameter form or a digital form. Specifically, the first enable identifier information may be a parameter written in a profile, or may be a value of a flag, which is not specifically limited here.

Exemplarily, the first value may be set to 1 and the second value may be set to 0. Alternatively, the first value may be set to 0 and the second value may be set to 1. Alternatively, the first value may be set to true and the second value may be set to false. Alternatively, the first value may be set to false and the second value may be set to true. In the embodiment of the present disclosure, the first value is set to 0 and the second value is set to 1, but which is not specifically limited here.

That is, in the embodiment of the present disclosure, as a syntax element transmitted in the bitstream, the first enable identifier information may be encoded and signalled in a bitstream. Exemplarily, for the first enable identifier information (i.e., octree adjacent child node enable flag bit) occtree_adjacent_child_enabled, if the octree adjacent child node enable flag bit indicates that the octree adjacent child node is not enabled, the value of occtree_adjacent_child_enabled may be determined to be 0, and if the octree adjacent child node enable flag bit indicates that the octree adjacent child node is enabled, the value of occtree_adjacent_child_enabled may be determined to be 1. In this way, after the value of occtree_adjacent_child_enabled is determined, the value of occtree_adjacent_child_enabled may be encoded and signalled in a bitstream. Subsequently, the value of occtree_adjacent_child_enabled may be directly obtained by decoding the bitstream at the decoding end, thereby improving decoding efficiency.

It should be noted that, in the process of determining the first context indication information, in addition to the value of occtree_adjacent_child_enabled, for the encoding parameter information at this time, specifically, in some embodiments, the operation of determining the encoding parameter information required by the current node in the encoding process may include: determining plane information of a sibling node of the current node among the encoded nodes, plane information of an encoded node situated along the preset direction of the current node, and occupancy information of an adjacent node situated along the preset direction of the current node.

That is, in the embodiment of the present disclosure, according to the value of occtree_adjacent_child_enabled, the first context indication information may be determined by calculating in combination with the plane information of the sibling node of the current node among the encoded nodes, the plane information of the encoded node situated along the preset direction of the current node, and the occupancy information of the adjacent node situated along the preset direction of the current node.

Further, in some embodiments, the operation of determining the first context indication information of the current node according to the first enable identifier information and the encoding parameter information may include the following operation.

When the first enable identifier information indicates that the octree adjacent child node is not enabled, the first context indication information is determined by calculating according to the occupancy information of the adjacent node situated along the preset direction of the current node and the plane information of the sibling node of the current node.

Alternatively, when the first enable identifier information indicates that the octree adjacent child node is enabled, the first context indication information is determined by calculating according to the plane information of the encoded node situated along the preset direction of the current node.

It should be noted that, in the embodiment of the present disclosure, if the value of occtree_adjacent_child_enabled is 0, in this case, the first context indication information may be obtained by calculating according to occupancy information of the adjacent node situated along the preset direction of the current node and the plane information of the sibling node of the current node. If the value of occtree_adjacent_child_enabled is 1, in this case, the first context indication information may be obtained by calculating according to the plane information of the encoded node situated along the preset direction of the current node.

It should also be noted that, in the embodiment of the present disclosure, the plane information of the encoded node situated along the preset direction of the current node may specifically refer to the first plane information and the second plane information of the encoded node situated along the preset direction of the current node. Therefore, in some embodiments, the method may further include the following operations.

The first plane information and the second plane information of the encoded node situated along the preset direction of the current node are determined according to the encoding parameter information.

When the first enable identifier information indicates that the octree adjacent child node is enabled, the first context indication information is determined by calculating according to the first plane information and the second plane information of the encoded node situated along the preset direction of the current node.

That is, in the embodiment of the present disclosure, if the value of occtree_adjacent_child_enabled is 1, in this case, the first context indication information may be specifically obtained by calculating according to the first plane information and the second plane information of the encoded node situated along the preset direction of the current node.

In some embodiments, for the first plane information and the second plane information, if the first plane information is lower than the second plane information, the first plane information may be referred to as low plane information, and the second plane information may be referred to as high plane information, and if the first plane information is higher than the second plane information, the first plane information may be referred to as high plane information, and the second plane information may be referred to as low plane information. Exemplarily, if the first plane information is lower than the second plane information, the first plane information may be represented by adjNeighPlaneL, and the second plane information may be represented by adjNeighPlaneH.

In addition, in the embodiment of the present disclosure, for the encoding parameter information, the occupancy information of the adjacent node situated along the preset direction of the current node may be represented by adjNeighHL, the plane information of the sibling node of the current node may be represented by sibPlaneH, and the plane information of the encoded node situated along the preset direction of the current node may be represented by adjNeighPlaneL and adjNeighPlaneH.

It should also be understood that, in the embodiment of the present disclosure, the determination of the value of the second context indication information is not only related to the encoding parameter information, but also has an associated relationship with the second enable identifier information. In some embodiments, the operation of determining the second enable identifier information may include the following operation.

When the octree planar buffer is not disabled, it is determined that the value of the second enable identifier information is the first value.

When the octree planar buffer is disabled, it is determined that the value of the second enable identifier information is the second value.

Further, in some embodiments, the method may further include the following operation. The value of the second enable identifier information is encoded to signal obtained encoded bits in the bitstream.

In the embodiment of the present disclosure, the first value and the second value are also different from each other for the second enable identifier information, and the first value and the second value may be in a parameter form or a digital form. Specifically, the second enable identifier information may be a parameter written in a profile, or may be a value of a flag, which is not specifically limited here.

Exemplarily, the first value may be set to 1 and the second value may be set to 0. Alternatively, the first value may be set to 0 and the second value may be set to 1. Alternatively, the first value may be set to true and the second value may be set to false. Alternatively, the first value may be set to false and the second value may be set to true. In the embodiment of the present disclosure, the first value is set to 0 and the second value is set to 1, but which is not specifically limited here.

That is, in the embodiment of the present disclosure, as a syntax element transmitted in the bitstream, the second enable identifier information may be encoded and signalled in a bitstream. Exemplarily, for the second enable identifier information (i.e., octree planar buffer close flag bit) occtree_planar_buffer_disabled, if the octree planar buffer close flag bit indicates that the octree planar buffer is not disabled, the value of occtree_planar_buffer_disabled may be determined to be 0, and if the octree planar buffer close flag bit indicates that the octree planar buffer is disabled, the value of occtree_planar_buffer_disabled may be determined to be 1. In this way, after the value of occtree_planar_buffer_disabled is determined, the value of occtree_planar_buffer_disabled may be encoded and signalled in a bitstream. Subsequently, the value of occtree_planar_buffer_disabled may be directly obtained by decoding the bitstream at the decoding end, thereby improving decoding efficiency.

It should be noted that, in the process of determining the second context indication information, in addition to the value of occtree_planar_buffer_disabled, for the encoding parameter information at this time, specifically, in some embodiments, the operation of determining the encoding parameter information required by the current node in the encoding process may include: determining plane information of an adjacent node in a plane perpendicular to the preset direction of the current node and closest plane position information in the plane perpendicular to the preset direction of the current node.

That is, in the embodiment of the present disclosure, according to the value of occtree_planar_buffer_disabled, the second context indication information may be determined by calculating in combination with plane information of an adjacent node in the plane perpendicular to the preset direction of the current node and the closest plane position information in the plane perpendicular to the preset direction of the current node.

Further, in some embodiments, the operation of determining the second context indication information of the current node according to the second enable identifier information and the encoding parameter information may include the following operation.

When the second enable identifier information indicates that the octree planar buffer is not disabled, the second context indication information is determined by calculating according to the closest plane position information in the plane perpendicular to the preset direction of the current node.

Alternatively, when the second enable identifier information indicates that the octree planar buffer is disabled, the second context indication information is determined by calculating according to the plane information of the adjacent node in the plane perpendicular to the preset direction of the current node.

It should be noted that, in the embodiment of the present disclosure, if the value of occtree_planar_buffer_disabled is 0, in this case, the second context indication information may be obtained by calculating according to the closest plane position information in the plane perpendicular to the preset direction of the current node, and if the value of occtree_planar_buffer_disabled is 1, in this case, the second context indication information may be obtained by calculating according to the plane information of the adjacent node in the plane perpendicular to the preset direction of the current node.

Further, in the embodiment of the present disclosure, the plane information of the adjacent node in the plane perpendicular to the preset direction of the current node may specifically refer to the third plane information and the fourth plane information of the adjacent node in the plane perpendicular to the preset direction of the current node. Accordingly, in some embodiments, the method may further include the following operations.

The third plane information and the fourth plane information of the adjacent node in the plane perpendicular to the preset direction of the current node are determined according to the encoding parameter information.

When the second enable identifier information indicates that the octree planar buffer is disabled, the second context indication information is determined by calculating according to the third plane information and the fourth plane information of the adjacent node in the plane perpendicular to the preset direction of the current node.

That is, in the embodiment of the present disclosure, if the value of occtree_planar_buffer_disabled is 1, in this case, the second context indication information may be specifically obtained by calculating according to the third plane information and the fourth plane information of the adjacent node in the plane perpendicular to the preset direction of the current node.

In some embodiments, for the third plane information and the fourth plane information, if the third plane information is lower than the fourth plane information, the third plane information may be referred to as low plane information, and the fourth plane information may be referred to as high plane information. If the third plane information is higher than the fourth plane information, the third plane information may be referred to as high plane information, and the fourth plane information may be referred to as low plane information. Exemplarily, if the third plane information is lower than the fourth plane information, the third plane information may be represented by closestPlaneL, and the fourth plane information may be represented by closestPlaneH.

Further, in the embodiment of the present disclosure, for the encoding parameter information, the closest plane position information in the plane perpendicular to the preset direction of the current node may be represented by closestPlanePos. In some embodiments, the operation of determining the closest plane position information in the plane perpendicular to the preset direction of the current node may include the following operations. Target plane position information of a previous node located in the plane perpendicular to the preset direction and meeting a condition of single-plane occupancy is determined. The closest plane position information in the plane perpendicular to the preset direction of the current node is determined by calculating according to the third plane information and the fourth plane information of the adjacent node in the plane perpendicular to the preset direction of the current node and the target plane position information.

It should be noted that, in the embodiment of the present disclosure, it is assumed that the preset direction is the k direction, the target plane position information of a previous node located in the plane perpendicular to the k direction and meeting a condition of single-plane occupancy may be represented by PrevOccPlanePos[k][axisLoc]. Here, k represents the k direction, and axisLoc represents being located in an axisLoc plane perpendicular to the k direction.

Thus, taking the k direction as an example, the closest plane position information closestPlanePos in the plane perpendicular to the k direction of the current node may be specifically obtained by calculating according to low plane information closestPlaneL and high plane information closestPlaneH in the adjacent node in the plane perpendicular to the k direction of the current node, and the plane position information PrevOccPlanePos[k][axisLoc] of a previous node located in the plane perpendicular to the k direction of the current node and meeting a condition of single-plane occupancy.

In operation S503, a context model is determined based on the context indication information.

In operation S504, plane position information of the current node in a preset direction is determined according to a planar coding mode, the plane position information of the current node in the preset direction is encoded based on the context model to signal obtained encoded bits in a bitstream.

It should be noted that, in the embodiment of the present disclosure, the context model is specifically determined according to a model index value. In some embodiments, the operation of determining the context model according to the context indication information may include the following operations. A model index value is determined by calculating according to the preset direction, the first context indication information, and the second context indication information. The context model is determined according to the model index value.

In the embodiment of the present disclosure, the model index value may be represented by CtxIdxPlanePos. The model index value may be obtained by calculating according to the preset direction, the first context indication information, and the second context indication information. Here, the first context indication information may also be referred to as an adjacent plane context indicator, which is represented by adjPlaneCtxInc, and the second context indication information may also be referred to as a closest plane position context indicator, which is represented by closestPlanePosCtxInc.

In this way, after the model index value is determined, the corresponding context model may be determined according to the model index value, and then, after determining the plane position information of the current node in the preset direction according to the planar coding mode, it is assumed that the preset direction is the k direction, and the plane position information of the current node may be represented by occ_plane_pos[k]. In this case, the plane position information occ_plane_pos[k] may be encoded according to the determined context model and the plane position information occ_plane_pos[k] may be signalled in a bitstream. In this way, subsequently, the plane position information occ_plane_pos[k] of the current node may be obtained by decoding at the decoding end according to the determined context model.

Further, in some embodiments, the method may further include storing plane position information of the current node in the preset direction to a preset plane position variable when the second enable identifier information indicates that the octree planar buffer is not disabled.

In the embodiment of the present disclosure, the preset plane position variable represents plane position information of a previous node located in a preset plane perpendicular to the preset direction and meeting a condition of single-plane occupancy, which may be represented by PrevOccPlanePos[k][axisLoc].

Specifically, taking the preset direction as the k direction as an example, if the value of the second enable identifier information is equal to 0, that is, the second enable identifier information indicates that the octree planar buffer is not disabled, then after the plane position information of the current node in the k direction is obtained by planar mode encoding, the plane position information of the current node in the k direction may be stored into the previous plane position variable PrevOccPlanePos[k][axisLoc], which represents the plane position of a previous node located in the axisLoc plane perpendicular to the k direction and meeting a condition of single-plane occupancy. If the value of this variable is equal to 0, it is represented as a low plane position. Otherwise, if the value of this variable is equal to 1, it is represented as a high plane position.

Further, the embodiments of the present disclosure further provide a bitstream. The bitstream is generated by bit encoding according to to-be-encoded information. The to-be-encoded information may include at least one of the following: plane position information of a current node in a preset direction, a value of the first enable identifier information, or a value of the second enable identifier information.

It should be noted that, in the embodiment of the present disclosure, the encoding terminal may encode the value of the first enable identifier information occtree_adjacent_child_enabled, the value of the second enable identifier information occtree_planar_buffer_disabled, and the plane position information occ_plane_pos[k] of the current node, and signal the value of the first enable identifier information occtree_adjacent_child_enabled, the value of the second enable identifier information occtree_planar_buffer_disabled, and the plane position information occ_plane_pos[k] of the current node in a bitstream. Subsequently, these pieces of information may be determined by decoding at the decoding end, and then the first context indication information adjPlaneCtxInc and the second context indication information closestPlanePosCtxInc may be determined, and the model index value of the context model may be further determined, so that the plane position information occ_plane_pos[k] of the current node may be decoded according to the context model.

The present embodiment provides a method for encoding. The first parameter information of a current node is determined. Context indication information of the current node is determined according to the first parameter information. A context model is determined according to the context indication information. The plane position information of the current node in the preset direction is determined according to the planar coding mode. The plane position information of the current node in the preset direction is encoded based on the context model, and the obtained encoded bits are signalled in a bitstream. In this way, in the process of encoding the plane position information of the current node in the preset direction by using the context model, the construction of the context model may be determined according to the first parameter information of the current node, and the amount of stored information of the first parameter information is reduced compared with the information amount required to be stored in the related art, thereby saving the storage space on the premise of ensuring the encoding performance.

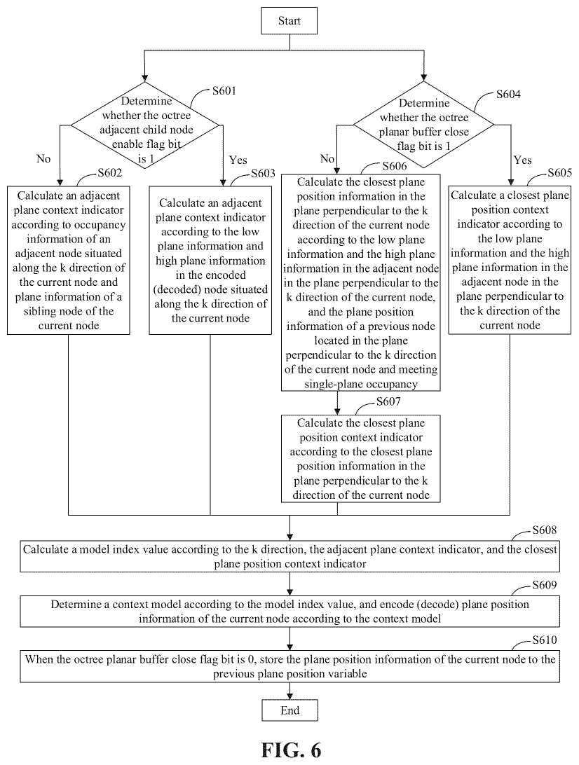

In still another embodiment of the present disclosure, based on the method for encoding and the method for decoding described in the foregoing embodiments, FIG. 6 illustrates a detailed flowchart of a method for encoding and decoding according to an embodiment of the present disclosure. As illustrated in FIG. 6, taking the k direction as an example, the specific operations may include the following operations.

In operation S601, it is determined whether the octree adjacent child node enable flag bit is 1.

In operation S602, an adjacent plane context indicator is calculated according to occupancy information of an adjacent node situated along the k direction of the current node and plane information of a sibling node of the current node.

In operation S603, an adjacent plane context indicator is calculated according to the low plane information and high plane information in the encoded (decoded) node situated along the k direction of the current node.

In operation S604, it is determined whether the octree planar buffer close flag bit is 1.

In operation S605, a closest plane position context indicator is calculated according to the low plane information and the high plane information in the adjacent node in the plane perpendicular to the k direction of the current node.

In operation S606, the closest plane position information in the plane perpendicular to the k direction of the current node is calculated according to the low plane information and the high plane information in the adjacent node in the plane perpendicular to the k direction of the current node, and the plane position information of a previous node located in the plane perpendicular to the k direction of the current node and meeting a condition of single-plane occupancy.

In operation S607, the closest plane position context indicator is calculated according to the closest plane position information in the plane perpendicular to the k direction of the current node.

In operation S608, a model index value is calculated according to the k direction, the adjacent plane context indicator, and the closest plane position context indicator.

In operation S609, a context model is determined according to the model index value, and plane position information of the current node is encoded (decoded) according to the context model.

In operation S610, when the octree planar buffer close flag bit is 0, the plane position information of the current node is stored to the previous plane position variable.

It should be noted that, in the embodiment of the present disclosure, in operation S601, if the determination result is NO, that is, the octree adjacent child node enable flag bit is 0, then the operation S602 may be performed to calculate the adjacent plane context indicator, and if the determination result is YES, that is, the octree adjacent child node enable flag bit is 1, then the operation S603 may be performed to calculate the adjacent plane context indicator.

Further, in the embodiment of the present disclosure, in the operation S604, if the determination result is YES, that is, the octree planar buffer close flag bit is 1, then the operation S605 may be perform to calculate the closest plane position context indicator, and if the determination result is NO, that is, the octree planar buffer close flag bit is 0, then the operation S606 and S607 may be performed to calculate the closest plane position context indicator.

That is, in the embodiment of the present disclosure, only the plane information of the nodes that are encoded and decoded by using the planar coding mode and the occupancy information of the adjacent node may be used. A new method for constructing the context model is proposed here to be used for encoding and decoding the flag bit occ_plane_pos[k].

In a specific embodiment, the implementation processes of the technical solution of the embodiment of the present disclosure at the encoding end and the decoding end are consistent. The specific implementation is described as follows.

(1) The plane position information occ_plane_pos[k] of the current node is encoded and decoded by using the planar coding mode, and the model index value CtxIdxPlanePos of the context of the plane position information occ_plane_pos[k] of the current node may be calculated according to the direction k, the adjacent plane context indicator adjPlaneCtxInc, and the closest plane position context indicator closestPlanePosCtxInc.

(2) When the value of the octree adjacent child node enable flag bit occtree_adjacent_child_enabled is 0, the adjacent plane context indicator adjPlaneCtxInc may be calculated according to the occupancy information adjNeighHL of the adjacent node situated along the k direction of the current node and the plane information sibPlaneH of a sibling node of the current node.

(3) When the value of the octree adjacent child node enable flag bit occtree_adjacent_child_enabled is 1, the adjacent plane context indicator adjPlaneCtxInc may be calculated according to the low plane information adjNeighPlaneL and high plane information adjNeighPlaneH in the encoded (decoded) node situated along the k direction of the current node.

(4) When the value of the octree planar buffer close flag t bit occtree_planar_buffer_disabled is 1, the closest plane position context indicator closestPlanePosCtxInc may be calculated according to low plane information closestPlaneL and high plane information closestPlaneH in the adjacent node in the plane perpendicular to the k direction of the current node.

(5) When the value of the octree planar buffer close flag bit occtree_planar_buffer_disabled is 0, the closest plane position context indicator closestPlanePosCtxInc may be calculated according to closest plane position information closestPlanePos in the plane perpendicular to the k direction of the current node.

(6) The closest plane position information closestPlanePos in the plane perpendicular to the k direction of the current node may be calculated according to the low plane information closestPlaneL and the high plane information closestPlaneH in the adjacent node in the plane perpendicular to the k direction of the current node, and the plane position information PrevOccPlanePos[k][axisLoc] of a previous node located in the plane perpendicular to the k direction of the current node and meeting a condition of single-plane occupancy.

(7) When the value of the octree planar buffer close flag bit occtree_planar_buffer_disabled is 0, the plane position information of the current node after encoding and decoding by using planar mode is stored in the previous plane position variable PrevOccPlanePos[k][axisLoc], which represents the plane position of a previous node located in the axisLoc plane perpendicular to the k direction and meeting a condition of single-plane occupancy, here 0 represents the low plane and 1 represents the high plane.

In summary, it can be seen that in the technical solution of the embodiment of the present disclosure, only the plane information of the nodes that are encoded and decoded by using the planar coding mode and the occupancy information of the adjacent node (and its child node) are used, and a new method for constructing the context model is proposed here to be used for encoding and decoding the flag bit occ_plane_pos[k]. Compared with the related art, about 86% of the storage space can be saved through the technical solution of the embodiment of the present disclosure, and a small performance loss is brought, specifically see Table 1 and Table 2. Table 1 illustrates the distortion performance (which may be represented by BD-Rate) under lossy compression of geometric information. Here, the BD-Rate under lossy compression of geometric information represents: compared with the related art, under the condition of obtaining the same encoding quality, saving percentage (BD-Rate is negative) or increasing percentage (BD-Rate is positive) for the encoding code rate of the technical solution compared with the encoding code rate of the related art. Table 2 illustrates the distortion performance (which can be expressed by Bpip Ratio) under lossless compression of geometric information. Here, the Bpip Ratio under the lossless compression of geometric information represents the percentage of the encoding code rate of the present technical solution to the encoding code rate of the related art without loss of point cloud quality. The lower the value is, the greater the code rate saved by the present technical solution is.

TABLE 1

Geometry BD-
TotalRate (%)

| Test sequence | D1 | D2 |
|---|---|---|
| Cat1-A average | 0.0% | 0.0% |
| Cat1-B average | 0.3% | 0.3% |
| Cat3-fused average | 0.1% | 0.1% |
| Cat3-frame average | 0.0% | 0.0% |
| Overall average | 0.1% | 0.1% |

TABLE 2

| | Geometry bpip |
|---|---|
| | ratio (%) |
| Test sequence | D1 |
| Cat1-A average | 100.3% |
| Cat1-B average | 100.4% |
| Cat3-fused average | 100.3% |
| Cat3-frame average | 100.0% |
| Overall average | 100.3% |

In the embodiment of the present disclosure, the specific implementation of the aforementioned embodiments is described in detail through the aforementioned embodiment, from which it can be seen that according to the technical solution of the aforementioned embodiment, in the process of encoding and decoding the plane position information of the current node in the preset direction by using the context model, the construction of the context model may be determined according to the first parameter information of the current node. Compared with the amount of information required to be stored in the related art, the amount of stored information of the first parameter information is reduced, thereby saving the storage space on the premise of ensuring the encoding and decoding performance.

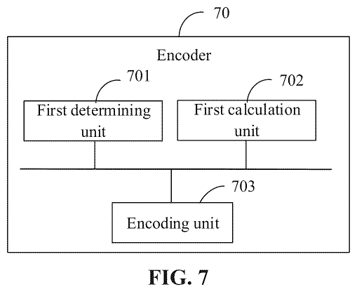

In still another embodiment of the present disclosure, based on the same inventive concept as the above embodiments, FIG. 7 illustrates a schematic diagram of a composition structure of an encoder according to an embodiment of the present disclosure. As illustrated in FIG. 7, the encoder 70 may include the first determining unit 701, the first calculation unit 702, and an encoding unit 703.

The first determining unit 701 is configured to determine the first parameter information of a current node.

The first calculation unit 702 is configured to determine context indication information of the current node according to the first parameter information, and determine a context model according to the context indication information.

The encoding unit 703 is configured to determine plane position information of the current node in a preset direction according to the planar coding mode, encode the plane position information of the current node in the preset direction based on the context model to signal obtained encoded bits in a bitstream.

In some embodiments, the first determining unit 701 is further configured to determine encoding parameter information required by the current node in an encoding process. The encoding parameter information includes at least one of: plane information of the encoded nodes, or occupancy information of an adjacent node.

In some embodiments, the first determining unit 701 is further configured to determine the first enable identifier information and the second enable identifier information.

The first calculation unit 702 is further configured to determine the first context indication information of the current node according to the first enable identifier information and the encoding parameter information, and determine the second context indication information of the current node according to the second enable identifier information and the encoding parameter information. The first enable identifier information indicates whether an octree adjacent child node is enabled, and the second enable identifier information indicates whether an octree planar buffer is disabled.

In some embodiments, the first determining unit 701 is further configured to determine plane information of a sibling node of the current node among the encoded nodes, plane information of an encoded node situated along the preset direction of the current node, and occupancy information of an adjacent node situated along the preset direction of the current node.

In some embodiments, when the first enable identifier information indicates that the octree adjacent child node is not enabled, the first calculation unit 702 is further configured to determine the first context indication information by calculating according to the occupancy information of the adjacent node situated along the preset direction of the current node and the plane information of the sibling node of the current node. Alternatively, when the first enable identifier information indicates that the octree adjacent child node is enabled, the first calculation unit 702 is further configured to determine the first context indication information by calculating according to the plane information of the encoded node situated along the preset direction of the current node.

In some embodiments, the first determining unit 701 is further configured to determine the first plane information and the second plane information of the encoded node situated along the preset direction of the current node according to the encoding parameter information.

When the first enable identifier information indicates that the octree adjacent child node is enabled, the first calculation unit 702 is further configured to determine the first context indication information by calculating according to the first plane information and the second plane information of the encoded node situated along the preset direction of the current node.

In some embodiments, the first determining unit 701 is further configured to determine that a value of the first enable identifier information is the first value when the first enable identifier information indicates that the octree adjacent child node is not enabled, and determine that the value of the first enable identifier information is the second value when the first enable identifier information indicates that the octree adjacent child node is enabled.

In some embodiments, the encoding unit 703 is further configured to encode the value of the first enable identifier information to signal obtained encoded bits in the bitstream.

In some embodiments, the first determining unit 701 is further configured to determine plane information of an adjacent node in a plane perpendicular to the preset direction of the current node and closest plane position information in the plane perpendicular to the preset direction of the current node.

In some embodiments, when the second enable identifier information indicates that the octree planar buffer is not disabled, the first calculation unit 702 is further configured to determine the second context indication information by calculating according to the closest plane position information in the plane perpendicular to the preset direction of the current node. Alternatively, when the second enable identifier information indicates that the octree planar buffer is disabled, the first calculation unit 702 is further configured to determine the second context indication information by calculating according to the plane information of the adjacent node in the plane perpendicular to the preset direction of the current node.

In some embodiments, the first determining unit 701 is further configured to determine the third plane information and the fourth plane information of the adjacent node in the plane perpendicular to the preset direction of the current node according to the encoding parameter information.

When the second enable identifier information indicates that the octree planar buffer is disabled, the first calculation unit 702 is further configured to determine the second context indication information by calculating according to the third plane information and the fourth plane information of the adjacent node in the plane perpendicular to the preset direction of the current node.

In some embodiments, the first determining unit 701 is further configured to determine target plane position information of a previous node located in the plane perpendicular to the preset direction and meeting a condition of single-plane occupancy.

The first calculation unit 702 is further configured to determine the closest plane position information in the plane perpendicular to the preset direction of the current node by calculating according to the third plane information and the fourth plane information of the adjacent node in the plane perpendicular to the preset direction of the current node and the target plane position information.

In some embodiments, the first determining unit 701 is further configured to determine that a value of the second enable identifier information is the first value when the octree planar buffer is not disabled, and determine that the value of the second enable identifier information is the second value when the octree planar buffer is disabled.

In some embodiments, the encoding unit 703 is further configured to encode the value of the second enable identifier information to signal obtained encoded bits in the bitstream.

In some embodiments, the first calculation unit 702 is further configured to determine a model index value by calculating according to the preset direction, the first context indication information, and the second context indication information.

The first determining unit 701 is further configured to determine the context model according to the model index value.

In some embodiments, the first determining unit 701 is further configured to store the plane position information of the current node in the preset direction to a preset plane position variable when the second enable identifier information indicates that the octree planar buffer is not disabled. The preset plane position variable represents plane position information of a previous node located in a preset plane perpendicular to the preset direction and meeting a condition of single-plane occupancy.

It may be understood that in the embodiments of the present disclosure, the “unit” may be a part of a circuit, a part of a processor, a part of a program or software, etc., and of course, it may also be a module, or may be non-modular. Moreover, in this embodiment, each component may be integrated in one processing unit, each unit may physically exist separately, or two or more units may be integrated in one unit. The above integrated unit may be implemented in the form of hardware or software functional modules.

If the integrated unit is implemented in the form of a software functional module and is not sold or used as an independent product, it may be stored in a computer readable storage medium. With this understanding, the technical solution of the present embodiment in essence or in part contributing to the prior art, or all or part of the technical solution may be embodied in the form of a software product. The computer software product is stored in a storage medium, and includes instructions for causing a computer device (which may be a personal computer, a server, a network device, etc.) or a processor to perform all or part of the steps of the methods of the present embodiments. The above storage medium includes a U disk, a removable hard disk, a Read Only Memory (ROM), a Random Access Memory (RAM), a magnetic disk or an optical disk and other medium capable of storing program codes.

Accordingly, the embodiments of the present disclosure provide a computer readable storage medium. The computer readable storage medium is applied to the encoder 70, and the computer readable storage medium stores a computer program. When the computer program is executed by the first processor, the method of any of the preceding embodiments is implemented.

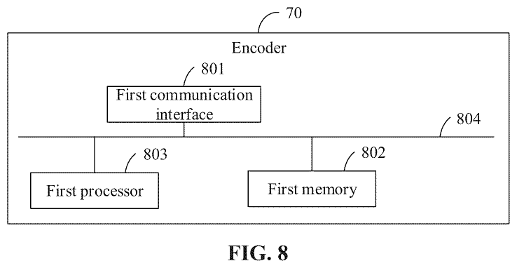

Based on the composition of the encoder 70 and the computer readable storage medium described above, FIG. 8 illustrates a schematic diagram of a specific hardware structure of the encoder 70 according to an embodiment of the present disclosure. As illustrated in FIG. 8, the encoder 70 may include the first communication interface 801, the first memory 802 and the first processor 803. The various components are coupled together by the first bus system 804. It may be understood that the first bus system 804 is used to implement connection communication between these components. The first bus system 804 includes a power bus, a control bus, and a status signal bus in addition to a data bus. However, for the sake of clarity of illustration, various buses are designated as the first bus system 804 in FIG. 8.

The first communication interface 801 is configured to receive and transmit signals in the process of transmitting and receiving information with other external network elements.

The first memory 802 is configured to store a computer program executable on the first processor 803.

The first processor 803 is configured, when executing the computer program, to perform: determining the first parameter information of a current node, determining context indication information of the current node according to the first parameter information, determining a context model according to the context indication information, determining plane position information of the current node in a preset direction according to a planar coding mode, and encoding the plane position information of the current node in the preset direction based on the context model to signal obtained encoded bits in a bitstream.

It is understood that the first memory 802 in the embodiment of the present disclosure may be a volatile memory or a non-volatile memory, or may include both volatile and non-volatile memory. The non-volatile memory may be a ROM, a Programmable ROM (PROM), an Erasable PROM (EPROM), an Electrically EPROM (EEPROM), or a flash memory. The volatile memory may be a RAM, which serves as an external cache. By way of illustration but not limitation, many forms of RAM are available, such as a static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM) and a Direct Rambus RAM (DRRAM). The first memory 802 of the systems and methods described herein is intended to include, but is not limited to, these and any other suitable type of memory.

The first processor 803 may be an integrated circuit chip having signal processing capabilities. In implementation, the operations of the above method may be completed by integrated logic circuitry of hardware in the first processor 803 or instructions in the form of software. The above-described first processor 803 may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, steps, and logical block diagrams disclosed in the embodiments of the present disclosure may be implemented or executed. The general purpose processor may be a microprocessor or the processor may be any conventional processor or the like. The steps of the method disclosed in connection with the embodiments of the present disclosure may be directly embodied as execution by the hardware decoding processor, or may be executed by combining hardware and software modules in the decoding processor. The software module may be located in a storage medium mature in the art, such as a RAM, a flash memory, a ROM, a PROM, or an EEPROM, a register, etc. The storage medium is located in the first memory 802, and the first processor 803 reads the information in the first memory 802, and completes the steps of the above method in combination with its hardware.

It will be understood that the embodiments described herein may be implemented in hardware, software, firmware, middleware, microcode, or combinations thereof. For hardware implementation, the processing unit may be implemented in one or more Application Specific Integrated Circuits (ASICs), Digital Signal Processors (DSPs), DSP Devices (DSPDs), Programmable Logic Devices (PLDs), Field-Programmable Gate Arrays (FPGAs), general purpose processors, controllers, microcontrollers, microprocessors, other electronic units for performing the functions described herein, or combinations thereof. For software implementations, the techniques described herein may be implemented by modules (e.g., procedures, functions, etc.) that perform the functions described herein. The software code may be stored in memory and executed by a processor. The memory may be implemented in the processor or external to the processor.

Alternatively, as another embodiment, the first processor 803 is further configured to perform the method of any one of the preceding embodiments when executing the computer program.

The present embodiment provides an encoder, in the encoder, in the process of encoding plane position information of a current node in a preset direction by using a context model, the construction of the context model may be determined according to the first parameter information of the current node, and the amount of stored information of the first parameter information is reduced compared with information amount required to be stored in a related art, thereby saving storage space on the premise of ensuring encoding performance.

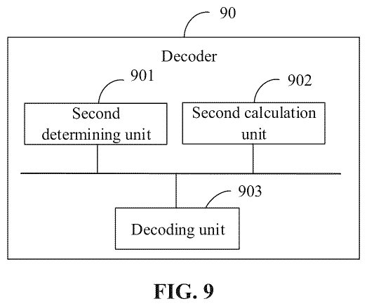

In still another embodiment of the present disclosure, based on the same inventive concept as the above-described embodiments, FIG. 9 illustrates a schematic diagram of a composition structure of a decoder according to an embodiment of the present disclosure. As illustrated in FIG. 9, the decoder 90 may include the second determining unit 901, the second calculation unit 902, and a decoding unit 903.

The second determining unit 901 is configured to determine the first parameter information of a current node.

The second calculation unit 902 is configured to determine context indication information of the current node according to the first parameter information, and determine a context model according to the context indication information.

The decoding unit 903 is configured to decode a bitstream based on the context model to determine plane position information of the current node in a preset direction.

In some embodiments, the second determining unit 901 is further configured to determine decoding parameter information required by the current node in a decoding process. The decoding parameter information includes at least one of: plane information of decoded nodes, or occupancy information of an adjacent node.

In some embodiments, the second determining unit 901 is further configured to determine the first enable identifier information and the second enable identifier information.

The second calculation unit 902 is configured to determine the first context indication information of the current node according to the first enable identifier information and the decoding parameter information, and determine the second context indication information of the current node according to the second enable identifier information and the decoding parameter information. The first enable identifier information indicates whether an octree adjacent child node is enabled, and the second enable identification information indicates whether an octree planar buffer is disabled.

In some embodiments, the second determining unit 901 is further configured to determine plane information of a sibling node of the current node among the decoded nodes, plane information of a decoded node situated along the preset direction of the current node, and occupancy information of an adjacent node situated along the preset direction of the current node.

In some embodiments, when the first enable identifier information indicates that the octree adjacent child node is not enabled, the second calculation unit 902 is further configured to determine the first context indication information by calculating according to the occupancy information of the adjacent node situated along the preset direction of the current node and the plane information of the sibling node of the current node. Alternatively, when the first enable identifier information indicates that the octree adjacent child node is enabled, the second calculation unit 902 is further configured to determine the first context indication information by calculating according to the plane information of the decoded node situated along the preset direction of the current node.

In some embodiments, the second determining unit 901 is further configured to determine the first plane information and the second plane information of the decoded node situated along the preset direction of the current node according to the decoding parameter information.

When the first enable identifier information indicates that the octree adjacent child node is enabled, the second calculation unit 902 is further configured to determine the first context indication information by calculating according to the first plane information and the second plane information of the decoded node situated along the preset direction of the current node.

In some embodiments, the decoding unit 903 is further configured to decode the bitstream to determine a value of the first enable identifier information.

In some embodiments, the second determining unit 901 is further configured to determine that the first enable identifier information indicates that the octree adjacent child node is not enabled when the value of the first enable identifier information is the first value, and determine that the first enable identifier information indicates that the octree adjacent child node is enabled when the value of the first enable identifier information is the second value.

In some embodiments, the second determining unit 901 is further configured to determine plane information of an adjacent node in a plane perpendicular to the preset direction of the current node and closest plane position information in the plane perpendicular to the preset direction of the current node.

In some embodiments, when the second enable identifier information indicates that the octree planar buffer is not disabled, the second calculation unit 902 is further configured to determine the second context indication information by calculating according to the closest plane position information in the plane perpendicular to the preset direction of the current node. Alternatively, when the second enable identifier information indicates that the octree planar buffer is disabled, the second calculation unit 902 is further configured to determine the second context indication information by calculating according to the plane information of the adjacent node in the plane perpendicular to the preset direction of the current node.

In some embodiments, the second determining unit 901 is further configured to determine the third plane information and the fourth plane information of the adjacent node in the plane perpendicular to the preset direction of the current node according to the decoding parameter information.

When the second enable identifier information indicates that the octree planar buffer is disabled, the second calculation unit 902 is further configured to determine the second context indication information by calculating according to the third plane information and fourth plane information of the adjacent node in the plane perpendicular to the preset direction of the current node.

In some embodiments, the second determining unit 901 is further configured to determine target plane position information of a previous node located in the plane perpendicular to the preset direction and meeting a condition of single-plane occupancy.

The second calculation unit 902 is further configured to determine the closest plane position information in the plane perpendicular to the preset direction of the current node by calculating according to the third plane information and the fourth plane information of the adjacent node in the plane perpendicular to the preset direction of the current node and the target plane position information.

In some embodiments, the decoding unit 903 is further configured to decode the bitstream to determine a value of the second enable identifier information.

In some embodiments, the second determining unit 901 is further configured to determine that the octree planar buffer is not disabled when the value of the second enable identifier information is the first value, and determine that the octree planar buffer is disabled when the value of the second enable identifier information is the second value.

In some embodiments, the second calculation unit 902 is further configured to determine a model index value by calculating according to the preset direction, the first context indication information, and the second context indication information.

The second determining unit 901 is further configured to determine the context model according to the model index value.

In some embodiments, the second determining unit 901 is further configured to store the plane position information of the current node in the preset direction to a preset plane position variable when the second enable identifier information indicates that the octree planar buffer is not disabled. The preset plane position variable represents plane position information of a previous node located in a preset plane perpendicular to the preset direction and meeting a condition of single-plane occupancy.

It may be understood that in the present embodiment, the “unit” may be a part of a circuit, a part of a processor, a part of a program or software, etc., and of course, it may also be a module, or may be non-modular. Moreover, in this embodiment, each component may be integrated in one processing unit, each unit may physically exist separately, or two or more units may be integrated in one unit. The above integrated unit may be implemented in the form of hardware or software functional modules.

If the integrated unit is implemented in the form of a software functional module and is not sold or used as an independent product, it may be stored in a computer readable storage medium. With this understanding, the present embodiment provides a computer readable storage medium. The computer readable storage medium is applied to the decoder 220, and the computer readable storage medium stores a computer program. When the computer program is executed by the second processor, the method of any of the preceding embodiments is implemented.

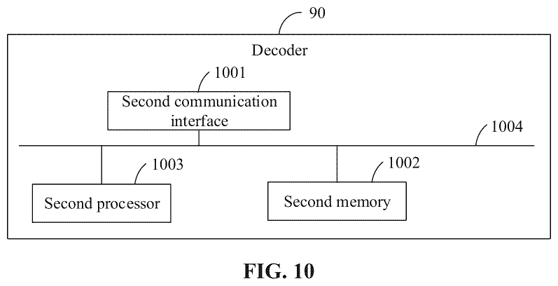

Based on the composition of the decoder 90 and the computer readable storage medium described above, FIG. 10 illustrates a schematic diagram of a specific hardware structure of the decoder 90 according to an embodiment of the present disclosure. As illustrated in FIG. 10, the decoder 90 may include the second communication interface 1001, the second memory 1002 and the second processor 1003. The various components are coupled together by the second bus system 1004. It may be understood that the second bus system 1004 is used to implement connection communication between these components. The second bus system 1004 includes a power bus, a control bus, and a status signal bus in addition to a data bus. However, for the sake of clarity of illustration, various buses are designated as the second bus system 1004 in FIG. 10.

The second communication interface 1001 is configured to receive and transmit signals in the process of transmitting and receiving information with other external network elements.

The second memory 1002 is configured to store a computer program executable on the second processor 1003.

The second processor 1003 is configured, when executing the computer program, to perform: determining the first parameter information of a current node, determining context indication information of the current node according to the first parameter information, determining a context model according to the context indication information, and decoding a bitstream based on the context model to determine plane position information of the current node in a preset direction.

Alternatively, as another embodiment, the second processor 1003 is further configured to perform the method of any of the preceding embodiments when executing the computer program.

It may be understood that the hardware function of the second memory 1002 is similar to that of the first memory 802, and the hardware function of the second processor 1003 is similar to that of the first processor 803, which will not be detailed here.

The present embodiment provides a decoder, in the decoder, in the process of decoding plane position information of a current node in a preset direction by using a context model, the construction of the context model may be determined according to the first parameter information of the current node, and the amount of stored information of the first parameter information is reduced compared with information amount required to be stored in a related art, thereby saving the storage space on the premise of ensuring the decoding performance.

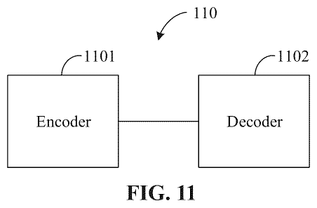

In yet another embodiment of the present disclosure, FIG. 11 illustrates a schematic diagram of a composition structure of an encoding and decoding system according to an embodiment of the present disclosure. As illustrated in FIG. 11, the encoding and decoding system 110 may include an encoder 1101 and a decoder 1102.

In an embodiment of the present disclosure, the encoder 1101 may be the encoder described in any of the preceding embodiments, and the decoder 1102 may be the decoder described in any of the preceding embodiments.

The embodiments of the present disclosure provide a method for encoding, a method for decoding, a bitstream, an encoder, a decoder, and a storage medium, which can save storage space.

The technical solutions of the embodiments of the present disclosure may be implemented as follows.

In the first aspect, the embodiments of the present disclosure provide a method for decoding. The method includes the following operations.

The first parameter information of a current node is determined.

Context indication information of the current node is determined according to the first parameter information.

A context model is determined according to the context indication information.

A bitstream is decoded based on the context model to determine plane position information of the current node in a preset direction.

In the second aspect, the embodiments of the present disclosure provide a method for encoding. The method includes the following operations.

The first parameter information of a current node is determined.

Context indication information of the current node is determined according to the first parameter information.

A context model is determined according to the context indication information.

Plane position information of the current node in a preset direction is determined according to a planar coding mode, and the plane position information of the current node in the preset direction is encoded based on the context model to signal obtained encoded bits in a bitstream.

In the third aspect, the embodiments of the present disclosure provide a bitstream. The bitstream is generated by bit encoding according to to-be-encoded information, and the to-be-encoded information includes at least one of the following: plane position information of a current node in a preset direction, a value of the first enable identifier information, or a value of the second enable identifier information.

In the fourth aspect, the embodiments of the present disclosure provide an encoder. The encoder includes the first determining unit, the first calculation unit, and an encoding unit.

The first determining unit is configured to determine the first parameter information of a current node.

The first calculation unit is configured to determine context indication information of the current node according to the first parameter information, and determine a context model according to the context indication information.

The encoding unit is configured to determine plane position information of the current node in the preset direction according to a planar coding mode, encode the plane position information of the current node in the preset direction based on the context model to signal obtained encoded bits in a bitstream.

In the fifth aspect, the embodiments of the present disclosure provide an encoder. The encoder includes the first memory and the first processor.

The first memory is configured to store a computer program executable on the first processor.

The first processor is configured to perform the method of the second aspect when executing the computer program.

In the sixth aspect, the embodiments of the present disclosure provide a decoder. The decoder includes the second determining unit, the second calculation unit, and a decoding unit.

The second determining unit is configured to determine the first parameter information of a current node.

The second calculation unit is configured to determine context indication information of the current node according to the first parameter information, and determine a context model according to the context indication information.

The decoding unit is configured to decode a bitstream based on the context model to determine plane position information of the current node in a preset direction.

In the seventh aspect, the embodiments of the present disclosure provide a decoder. The decoder includes the second memory and the second processor.

The second memory is configured to store a computer program executable on the second processor.

The second processor is configured to perform the method of the first aspect when executing the computer program.

In the eighth aspect, the embodiments of the present disclosure provide a computer readable storage medium. The computer readable storage medium stores a computer program that, when executed, implements the method of the first aspect or implements the method of the second aspect.

The embodiments of the present disclosure provide a method for encoding, a method for decoding, a bitstream, an encoder, a decoder, and a storage medium. Whether at an encoding end or a decoding end, the first parameter information of a current node is determined, context indication information of the current node is determined according to the first parameter information, and then the context model is determined according to the context indication information. In this way, at the encoding end, after the plane position information of the current node in the preset direction is determined according to the planar coding mode, the plane position information of the current node in the preset direction can be encoded based on the context model to signal the obtained encoded bits in a bitstream. At the decoding end, the bitstream is decoded based on the context model to determine the plane position information of the current node in the preset direction. That is, in the process of encoding and decoding the plane position information of the current node in the preset direction by using the context model, the construction of the context model may be determined according to the first parameter information of the current node. Compared with the amount of information required to be stored in the related art, the amount of stored information of the first parameter information is reduced, thereby saving the storage space on the premise of ensuring the encoding and decoding performance.

It should be noted that in the present disclosure, the terms “comprising”, “including” or any other variation thereof are intended to encompass a non-exclusive inclusion such that a process, method, article, or apparatus including a series of elements includes not only those elements, but also other elements not explicitly listed, or elements inherent to such a process, method, article, or apparatus. Without further limitation, an element defined by the statement “including a” does not preclude the presence of additional identical elements in a process, method, article, or apparatus that includes the element.

The above-described serial numbers of the embodiments of the present disclosure are for description only, and do not represent the advantages and disadvantages of the embodiments.

The methods disclosed in several method embodiments provided in the present disclosure may be arbitrarily combined without conflict to obtain new method embodiments.

The features disclosed in several product embodiments provided in the present disclosure may be arbitrarily combined without conflict to obtain new product embodiments.

The features disclosed in several method or device embodiments provided in the present disclosure may be arbitrarily combined without conflict to obtain new method or device embodiments.

The above is merely specific embodiments of the present disclosure, but the scope of protection of the present disclosure is not limited thereto, and any person skilled in the art can easily think of changes or substitutions within the technical scope disclosed in the present disclosure, which should be covered within the scope of protection of the present disclosure. Therefore, the scope of protection of the present disclosure should be based on the scope of protection of the claims.

### INDUSTRIAL PRACTICALITY

In the embodiments of the present disclosure, whether at an encoding end or a decoding end, the first parameter information of a current node is determined, context indication information of the current node is determined according to the first parameter information, and then the context model is determined according to the context indication information. In this way, at the encoding end, after the plane position information of the current node in the preset direction is determined according to the planar coding mode, the plane position information of the current node in the preset direction can be encoded based on the context model to signal the obtained encoded bits in a bitstream. At the decoding end, the bitstream is decoded based on the context model to determine the plane position information of the current node in the preset direction. That is, in the process of encoding and decoding the plane position information of the current node in the preset direction by using the context model, the construction of the context model may be determined according to the first parameter information of the current node. Compared with the amount of information required to be stored in the related art, the amount of stored information of the first parameter information is reduced, thereby saving the storage space on the premise of ensuring the encoding and decoding performance.

1. A method for decoding, applied to a decoder, the method comprising:
determining first parameter information of a current node;
determining context indication information of the current node according to the first parameter information;
determining a context model according to the context indication information; and
decoding a bitstream based on the context model to determine plane position information of the current node in a preset direction.

2. The method of claim 1, wherein determining the first parameter information of the current node comprises:
determining decoding parameter information required by the current node in a decoding process, wherein the decoding parameter information comprises at least one of: plane information of decoded nodes, or occupancy information of an adjacent node.

3. The method of claim 2, wherein determining the context indication information of the current node according to the first parameter information comprises:
determining first enable identifier information and second enable identifier information;
determining first context indication information of the current node according to the first enable identifier information and the decoding parameter information; and
determining second context indication information of the current node according to the second enable identifier information and the decoding parameter information,
wherein the first enable identifier information indicates whether an octree adjacent child node is enabled, and the second enable identifier information indicates whether an octree planar buffer is disabled.

4. The method of claim 3, wherein determining the decoding parameter information required by the current node in the decoding process comprises:
determining plane information of a sibling node of the current node among the decoded nodes, plane information of a decoded node situated along the preset direction of the current node, and occupancy information of an adjacent node situated along the preset direction of the current node.

5. The method of claim 4, wherein determining the first context indication information of the current node according to the first enable identifier information and the decoding parameter information comprises:
when the first enable identifier information indicates that the octree adjacent child node is not enabled, determining the first context indication information by calculating according to the occupancy information of the adjacent node situated along the preset direction of the current node and the plane information of the sibling node of the current node; or
when the first enable identifier information indicates that the octree adjacent child node is enabled, determining the first context indication information by calculating according to the plane information of the decoded node situated along the preset direction of the current node.

6. The method of claim 5, further comprising:
determining, according to the decoding parameter information, first plane information and second plane information of the decoded node situated along the preset direction of the current node; and
when the first enable identifier information indicates that the octree adjacent child node is enabled, determine the first context indication information by calculating according to the first plane information and the second plane information of the decoded node situated along the preset direction of the current node.

7. The method of claim 3, wherein determining the first enable identifier information comprises:
decoding the bitstream to determine a value of the first enable identifier information;
wherein the method further comprises:
when the value of the first enable identifier information is a first value, determining that the first enable identifier information indicates that the octree adjacent child node is not enabled; and
when the value of the first enable identifier information is a second value, determining that the first enable identifier information indicates that the octree adjacent child node is enabled.

8. The method of claim 3, wherein determining the decoding parameter information required by the current node in the decoding process comprises:
determining plane information of an adjacent node in a plane perpendicular to the preset direction of the current node and closest plane position information in the plane perpendicular to the preset direction of the current node.

9. The method of claim 8, wherein determining the second context indication information of the current node according to the second enable identifier information and the decoding parameter information comprises:
when the second enable identifier information indicates that the octree planar buffer is not disabled, determining the second context indication information by calculating according to the closest plane position information in the plane perpendicular to the preset direction of the current node; or
when the second enable identifier information indicates that the octree planar buffer is disabled, determining the second context indication information by calculating according to the plane information of the adjacent node in the plane perpendicular to the preset direction of the current node.

10. The method of claim 9, further comprising:
determining, according to the decoding parameter information, third plane information and fourth plane information of the adjacent node in the plane perpendicular to the preset direction of the current node; and
when the second enable identifier information indicates that the octree planar buffer is disabled, determining the second context indication information by calculating according to the third plane information and the fourth plane information of the adjacent node in the plane perpendicular to the preset direction of the current node.

11. The method of claim 10, wherein determining the closest plane position information in the plane perpendicular to the preset direction of the current node comprises:
determining target plane position information of a previous node located in the plane perpendicular to the preset direction and meeting a condition of single-plane occupancy; and
determining the closest plane position information in the plane perpendicular to the preset direction of the current node by calculating according to the third plane information and the fourth plane information of the adjacent node in the plane perpendicular to the preset direction of the current node and the target plane position information.

12. The method of claim 3, wherein determining the second enable identifier information comprises:
decoding the bitstream to determine a value of the second enable identifier information;
wherein the method further comprises:
when the value of the second enable identifier information is a first value, determining that the octree planar buffer is not disabled; and
when the value of the second enable identifier information is a second value, determining that the octree planar buffer is disabled.

13. The method of claim 3, wherein determining the context model according to the context indication information comprises:
determining a model index value by calculating according to the preset direction, the first context indication information, and the second context indication information; and
determining the context model according to the model index value.

14. The method of claim 3, further comprising:
when the second enable identifier information indicates that the octree planar buffer is not disabled, storing the plane position information of the current node in the preset direction to a preset plane position variable,
wherein the preset plane position variable represents plane position information of a previous node located in a preset plane perpendicular to the preset direction and meeting a condition of single-plane occupancy.

15. A method for encoding, applied to an encoder, the method comprising:
determining first parameter information of a current node;
determining context indication information of the current node according to the first parameter information;
determining a context model according to the context indication information; and
determining plane position information of the current node in a preset direction according to a planar coding mode, and encoding the plane position information of the current node in the preset direction based on the context model to signal obtained encoded bits in a bitstream.

16. The method of claim 15, wherein determining the first parameter information of the current node comprises:
determining encoding parameter information required by the current node in an encoding process, wherein the encoding parameter information comprises at least one of: plane information of encoded nodes, or occupancy information of an adjacent node.

17. The method of claim 16, wherein determining the context indication information of the current node according to the first parameter information comprises:
determining first enable identifier information and second enable identifier information;
determining first context indication information of the current node according to the first enable identifier information and the encoding parameter information; and
determining second context indication information of the current node according to the second enable identifier information and the encoding parameter information,
wherein the first enable identifier information indicates whether an octree adjacent child node is enabled, and the second enable identifier information indicates whether an octree planar buffer is disabled.

18. The method of claim 17, wherein determining the encoding parameter information required by the current node in the encoding process comprises:
determining plane information of a sibling node of the current node among the encoded nodes, plane information of an encoded node situated along the preset direction of the current node, and occupancy information of an adjacent node situated along the preset direction of the current node.

19. The method of claim 18, wherein determining the first context indication information of the current node according to the first enable identifier information and the encoding parameter information comprises:
when the first enable identifier information indicates that the octree adjacent child node is not enabled, determining the first context indication information by calculating according to the occupancy information of the adjacent node situated along the preset direction of the current node and the plane information of the sibling node of the current node; or
when the first enable identifier information indicates that the octree adjacent child node is enabled, determining the first context indication information by calculating according to the plane information of the encoded node situated along the preset direction of the current node.

20. A decoder, comprising:
a processor; and
a memory, configured to store a computer program executable by the processor,
wherein the processor is configured to:
determine first parameter information of a current node;
determine context indication information of the current node according to the first parameter information;
determine a context model according to the context indication information; and
decode a bitstream based on the context model to determine plane position information of the current node in a preset direction.
